(19) United States
(12) Patent Application Publication
(10) Pub. No.: US 2025/0376086 A1
(43) Pub. Date: Dec. 11, 2025

(54) VEHICLE SEAT

(71) Applicant: TACHI-S CO., LTD., Tokyo (JP)

(72) Inventors: Yasuhiro SUZUKI, Tokyo (JP); Mitsuhisa NAKAMURA, Tokyo (JP); Takeshi NISHINA, Tokyo (JP)

(73) Assignee: TACHI-S CO., LTD., Tokyo (JP)

(21) Appl. No.: 19/226,181

(22) Filed: Jun. 3, 2025

(30) Foreign Application Priority Data
Jun. 5, 2024 (JP) 2024-091617

(51) Int. Cl. B60N 2/16; B60N 2/02

(52) U.S. Cl. CPC B60N 2/1615; B60N 2/02253

(57) ABSTRACT

A vehicle seat includes a seat cushion, and a height adjustment mechanism for the seat cushion. The height adjustment mechanism includes a link member having one end pivotably supported by the seat cushion, and a support member provided between a placement surface on which the vehicle seat is placed and the seat cushion, and pivotably supporting the other end of the link member. The support member extends rearward than the other end of the link member. The vehicle seat includes a cover member with which an end portion of the support member on the rear side is covered. An end surface of the link member on a placement surface side is provided with a concave portion recessed to a side opposite to the placement surface. The concave portion is provided between a supported portion supported by the support member and a supported portion supported by the seat cushion.

### CROSS-REFERENCE TO RELATED APPLICATIONS

This application is based on and claims priority under 35 USC 119 from Japanese Patent Application No. 2024-091617 filed on Jun. 5, 2024, the entire content of which is incorporated herein by reference.

### TECHNICAL FIELD

The present disclosure relates to a vehicle seat.

### BACKGROUND ART

JP2016-101845A, JP2019-018711A and JP2016-203949A describe a vehicle seat having a height-adjustable mechanism.

An object of the present disclosure is to provide a vehicle seat capable of maintaining the aesthetic appearance and sufficiently ensuring a height adjustment range of a seat cushion.

### SUMMARY OF INVENTION

According to an aspect of the present disclosure, there is provided a vehicle seat including:
a seat cushion; and
a height adjustment mechanism for the seat cushion, in which
the height adjustment mechanism includes:
   a link member having one end pivotably supported by the seat cushion; and
   a support member provided between a placement surface on which the vehicle seat is placed and the seat cushion, and configured to pivotably support an other end of the link member,
the support member extends toward a rear side of the seat cushion than the other end of the link member,
the vehicle seat further includes a cover member with which an end portion of the support member on the rear side of the seat cushion is covered, and
an end surface of the link member on a side of the placement surface is provided with a concave portion recessed to a side opposite to the side of the placement surface, the concave portion being provided between a first supported portion supported by the support member and a second supported portion supported by the seat cushion.

### BRIEF DESCRIPTION OF DRAWINGS

Exemplary embodiment(s) of the present invention will be described in detail based on the following figures, wherein:

FIG. 1 is an external perspective view illustrating a schematic configuration of a vehicle seat 100 according to an embodiment of the technique of the present disclosure;

FIG. 2 is a partially enlarged perspective view schematically illustrating an internal configuration of the vehicle seat 100 illustrated in FIG. 1;

FIG. 3 is a partially enlarged perspective view schematically illustrating the internal configuration of the vehicle seat 100 illustrated in FIG. 1, as viewed from a direction different from that in FIG. 2;

FIG. 4 is a schematic diagram illustrating a view along an arrow A in FIG. 3;

FIG. 5 is a perspective view of the vicinity of a right rear link member 61R of the vehicle seat 100 as viewed from the rear;

FIG. 6 is a perspective view illustrating a cross section taken along a plane perpendicular to a left-right direction passing through a supported portion P1 of the right rear link member 61R;

FIG. 7 is a schematic cross-sectional view (1) illustrating the plane perpendicular to the left-right direction passing through a middle point in a thickness direction of the right rear link member 61R;

FIG. 8 is a schematic cross-sectional view (2) illustrating the plane perpendicular to the left-right direction passing through the middle point in the thickness direction of the right rear link member 61R; and

FIG. 9 is a schematic cross-sectional view (3) illustrating the plane perpendicular to the left-right direction passing through the middle point in the thickness direction of the right rear link member 61R.

### DESCRIPTION OF EMBODIMENTS

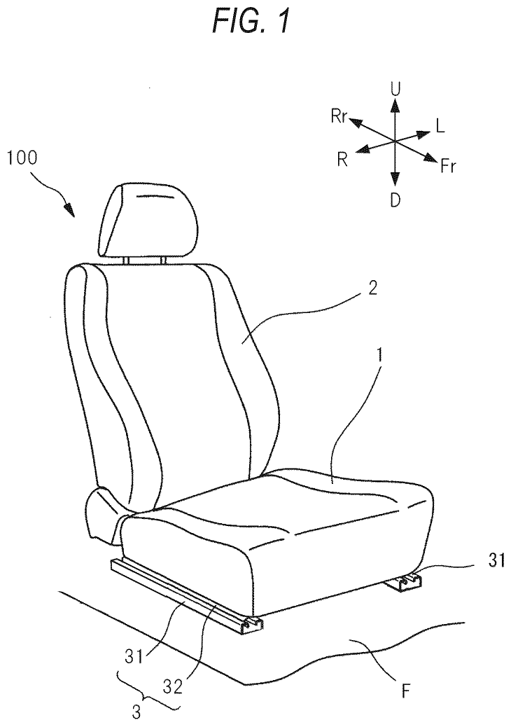

FIG. 1 is an external perspective view illustrating a schematic configuration of a vehicle seat 100 according to an embodiment of the technique of the present disclosure. The vehicle in the present specification includes an automatic vehicle, an aircraft, a train, a moving drone, a ship, and the like. In the following description, a front side of an occupant who sits in a normal posture on the vehicle seat 100 is referred to as a frontward direction Fr, a direction opposite to the frontward direction Fr is referred to as a rearward direction Rr, and the frontward and rearward directions are collectively referred to as a front-rear direction. A right side of the occupant when the occupant is viewed from a rear side is referred to as a rightward direction R, a left side of the occupant is referred to as a leftward direction L, and the leftward and rightward directions are collectively referred to as a left-right direction. A direction perpendicular to the front-rear direction and the left-right direction and extending from a head rest toward a seating surface is referred to as a downward direction D, a direction opposite to the downward direction D is referred to as an upward direction U, and the upward and downward directions are collectively referred to as an up-down direction. The front-rear direction, the left-right direction, and the up-down direction intersect with each other.

The vehicle seat 100 includes a seat cushion 1 that supports buttocks and thighs of the occupant, and a seat back 2 that supports a waist and a back of the occupant. In the example of FIG. 1, the vehicle seat 100 is a driver's seat or a passenger's seat of an automatic vehicle.

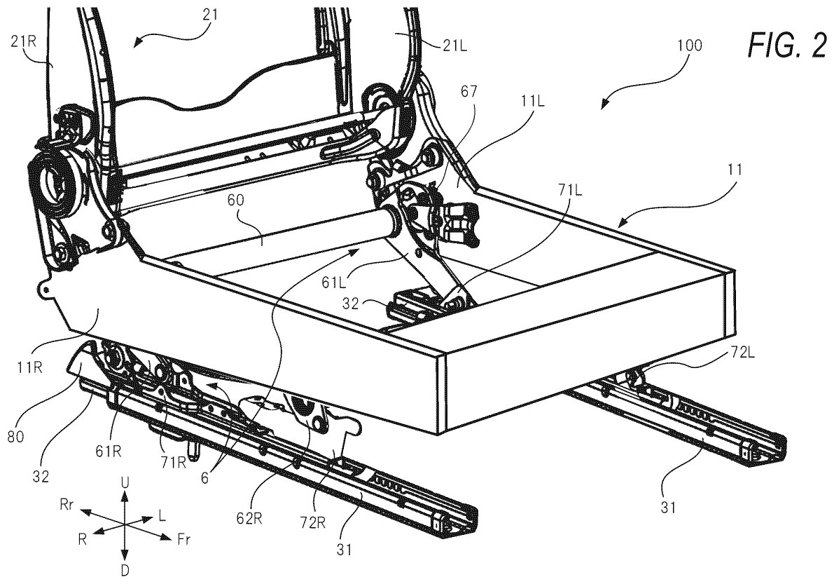

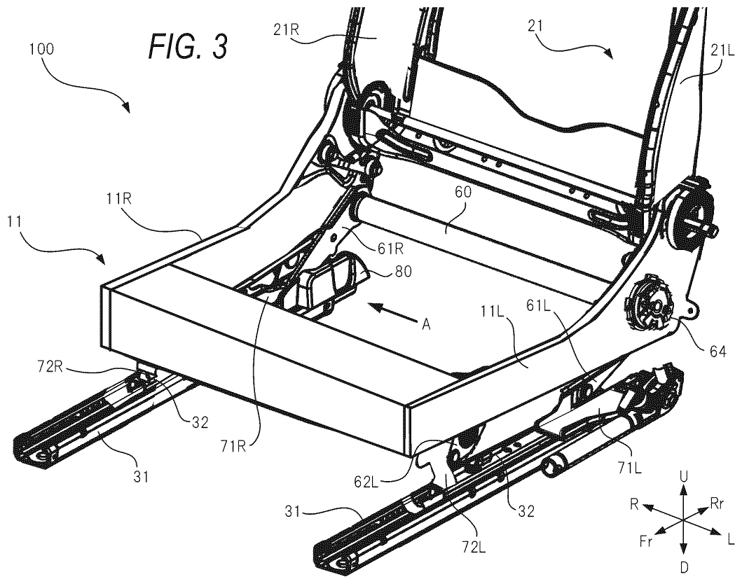

The seat cushion 1 includes a cushion frame 11 (see FIGS. 2 and 3) that forms a framework. The cushion frame 11 is covered with a pad (not illustrated) made of a relatively soft resin foam material such as urethane foam, and is further covered with a trim cover (not illustrated) including a skin material such as leather, woven fabric, or nonwoven fabric.

The seat back 2 includes a back frame 21 (see FIGS. 2 and 3) that forms a framework (not illustrated). The back frame 21 is covered with a pad (not illustrated) made of a relatively soft resin foam material such as urethane foam, and is further covered with a trim cover (not illustrated) including a skin material such as leather, woven fabric, or nonwoven fabric.

The vehicle seat 100 includes a pair of rail mechanisms 3 fixed to a vehicle body floor F and located directly below the seat cushion 1, and a foot bracket (not illustrated) disposed between the rail mechanisms 3 and the vehicle body floor F and supporting the seat cushion 1 from below via the rail mechanisms 3.

The rail mechanism 3 is located directly below the seat cushion 1 to support the seat cushion 1, and can cause the seat cushion 1 to move along the front-rear direction. The rail mechanism 3 includes two long rails extending in the front-rear direction, specifically, a lower rail 31 as a fixed rail and an upper rail 32 as a movable rail. The upper rail 32 can slide along a longitudinal direction (that is, the front-rear direction) of the lower rail 31 together with the seat cushion 1 supported on an upper surface thereof.

FIG. 2 is a partially enlarged perspective view schematically illustrating an internal configuration of the vehicle seat 100 illustrated in FIG. 1. FIG. 2 illustrates a state where a pad and a trim cover of the seat cushion 1 and a pad and a trim cover of the seat back 2 are removed. FIG. 3 is a partially enlarged perspective view schematically illustrating the internal configuration of the vehicle seat 100 illustrated in FIG. 1, as viewed from a direction different from that in FIG. 2.

The cushion frame 11 of the seat cushion 1 includes a left side frame 11L and a right side frame 11R arranged side by side in the left-right direction and extending in the front-rear direction. In the example of FIGS. 2 and 3, the left side frame 11L and the right side frame 11R are each formed in a plate shape having a thickness in the left-right direction.

The back frame 21 of the seat back 2 includes a left side frame 21L and a right side frame 21R arranged side by side in the left-right direction and extending in the up-down direction. In the example of FIGS. 2 and 3, the left side frame 21L and the right side frame 21R are each formed in a plate shape having a thickness in the left-right direction.

The vehicle seat 100 includes a seat lifter device 6 that adjusts a height position of the seat cushion 1 in the up-down direction. The seat lifter device 6 includes a parallel link mechanism, and includes a left rear link member 61L provided at the rear left, a right rear link member 61R provided at the rear right, a left front link member 62L provided at the front left, a right front link member 62R provided at the front right, and a cylindrical torque rod 60 made of a pipe material or the like, which rotatably passes through through holes that penetrate to the left and right and are formed in a rear end portion of the left side frame 11L and a rear end portion of the right side frame 11R, respectively. The right rear link member 61R, the left rear link member 61L, the right front link member 62R, and the left front link member 62L are each formed in a plate shape having a thickness in the left-right direction.

A riser 71R is fixed at a rear end portion, and a riser 72R is fixed at a front end portion to an upper surface of the right upper rail 32. A riser 71L is fixed at a rear end portion, and a riser 72L is fixed at a front end portion to an upper surface of the left upper rail 32.

The left rear link member 61L has one end pivotably supported by the cushion frame 11, and the other end pivotably supported by the riser 71L. Specifically, the left rear link member 61L has the other end pivotably coupled to the riser 71L via a hinge pin or the like, and the one end coupled to a left end portion of the torque rod 60.

The right rear link member 61R has one end pivotably supported by the cushion frame 11, and the other end pivotably supported by the riser 71R. Specifically, the right rear link member 61R has the other end pivotably coupled to the riser 71R via a hinge pin or the like, and the one end coupled to a right end portion of the torque rod 60.

The left front link member 62L has one end pivotably supported by the cushion frame 11, and the other end pivotably supported by the riser 72L. Specifically, the left front link member 62L has the other end pivotably coupled to the riser 72L via a hinge pin or the like, and the one end pivotably coupled to a front end portion of the left side frame 11L.

The right front link member 62R has one end pivotably supported by the cushion frame 11, and the other end pivotably supported by the riser 72R. Specifically, the right front link member 62R has the other end pivotably coupled to the riser 72R via a hinge pin or the like, and the one end pivotably coupled to a front end portion of the right side frame 11R.

A pinion gear 64 is provided at the rear end portion of the left side frame 11L. The left rear link member 61L is provided with a sector gear 67 that meshes with the pinion gear 64. The pinion gear 64 is coupled to a motor, an operating handle, or the like (not illustrated), and pivots when the motor is operated or the operating handle is operated. When the pinion gear 64 pivots, the sector gear 67 meshing with the pinion gear 64, the left rear link member 61L integrated with the sector gear 67, and the torque rod 60 coupled to the left rear link member 61L pivot about an axial center of the torque rod 60 as a pivoting center in accordance with the pivoting of the pinion gear 64. When the torque rod 60 pivots, the right rear link member 61R coupled to the torque rod 60 also pivots, the left front link member 62L and the right front link member 62R also pivot, and the cushion frame 11 moves in the up-down direction.

In this way, the left rear link member 61L, the right rear link member 61R, the left front link member 62L, the right front link member 62R, the torque rod 60, the left side frame 11L, the right side frame 11R, the riser 71L, the riser 71R, the riser 72L, and the riser 72R constitute the parallel link mechanism that causes the seat cushion 1 to move in the up-down direction while maintaining a posture with respect to the vehicle body floor F.

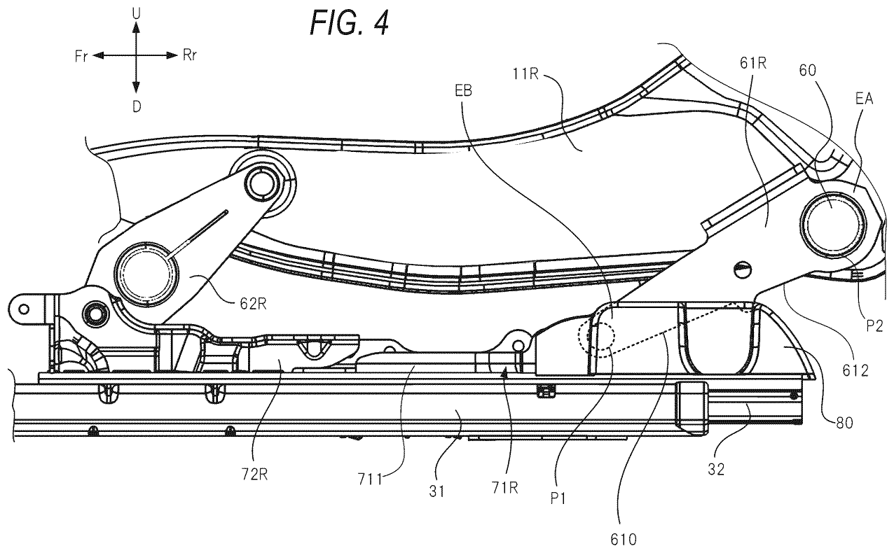

FIG. 4 is a schematic diagram illustrating a view along an arrow A in FIG. 3. The right rear link member 61R and the right front link member 62R are shaped to extend upward and rearward from the front and the below as viewed in the left-right direction. The right rear link member 61R is supported at a front and lower end portion EB by the riser 71R. FIG. 4 illustrates a supported portion P1 of the right rear link member 61R supported by the riser 71R. A rear and upper end portion EA of the right rear link member 61R is coupled to the torque rod 60, and a portion of the right rear link member 61R coupled to the torque rod 60 constitutes a supported portion P2 supported by the seat cushion 1. The right front link member 62R is supported at a front and lower end portion by the riser 72R, and at a rear and upper end portion by the right side frame 11R.

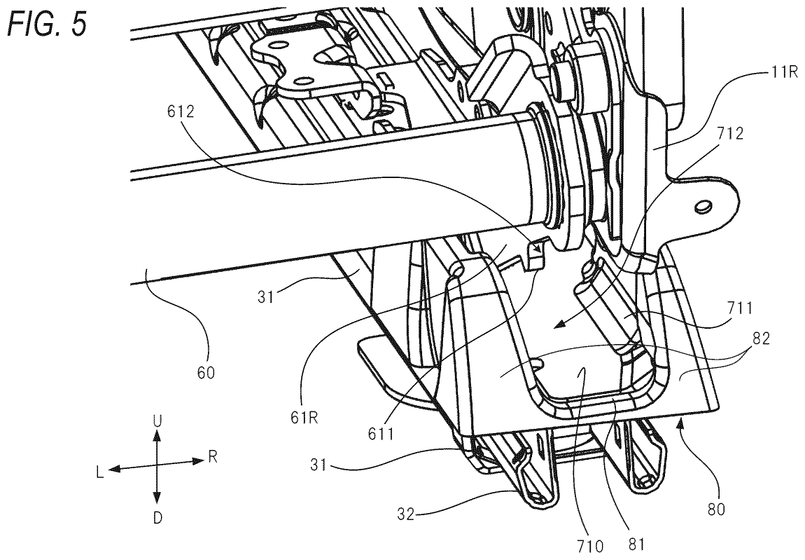

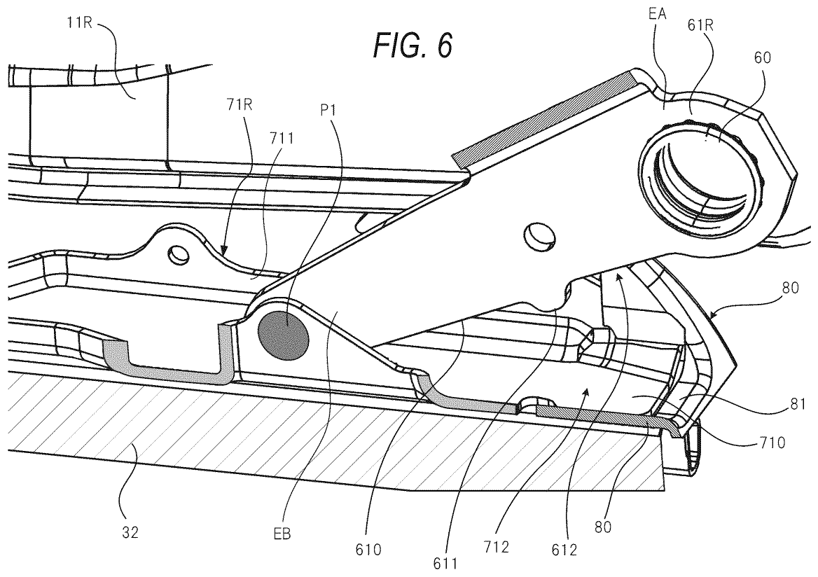

FIG. 5 is a perspective view of the vicinity of the right rear link member 61R of the vehicle seat 100 as viewed from the rear. FIG. 6 is a perspective view illustrating a cross section taken along a plane perpendicular to the left-right direction passing through the supported portion P1.

As illustrated in FIG. 6, the riser 71R has a flat plate-shaped bottom surface portion 710 having a thickness in the up-down direction and facing the upper surface of the upper rail 32, and a side surface portion 711 rising upward from an outer edge of the bottom surface portion 710, and has a portion extending rearward of the supported portion P1. The left side surface portion 711 of the riser 71R supports the end portion EB of the right rear link member 61R.

As illustrated in FIGS. 4 to 6, the vehicle seat 100 is provided with a cover member 80 with which a rear end portion 712 of the riser 71R is covered. The cover member 80 is provided to prevent feet or the like of a person located at the rear of the vehicle seat 100 from touching the end portion 712, to protect the end portion 712, and to improve the aesthetic appearance of the vehicle seat 100. The cover member 80 is fixed to the riser 71R by, for example, fitting or adhesion.

As illustrated in FIG. 5, the cover member 80 has an approximately U-shape when viewed in the front-rear direction, and has a first portion 81 facing a rear end surface of the bottom surface portion 710 of the riser 71R, and a second portion 82 facing a rear end surface of the side surface portion 711 of the riser 71R.

As illustrated in FIGS. 4 to 6, an end surface 610 of the right rear link member 61R on a vehicle body floor F side is provided with a concave portion 612 recessed to a side opposite to the vehicle body floor F side at a position between the supported portion P1 and the supported portion P2.

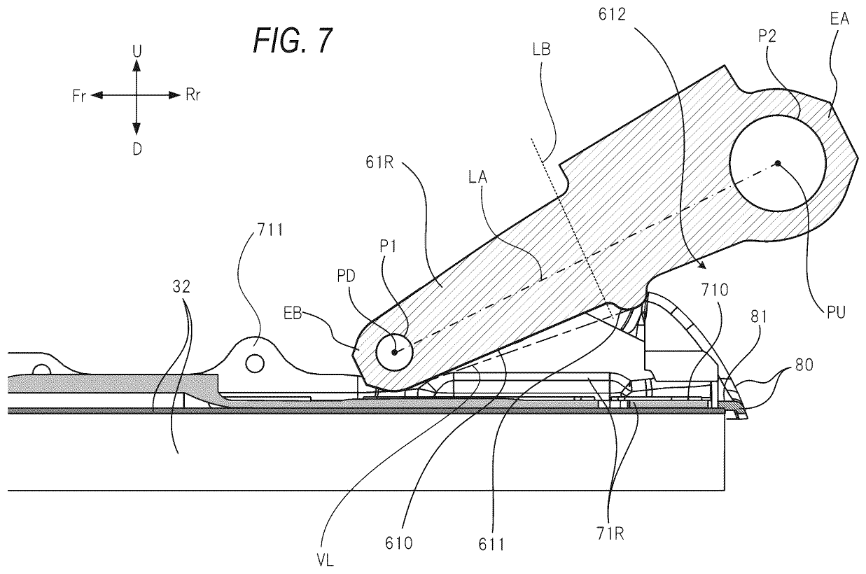

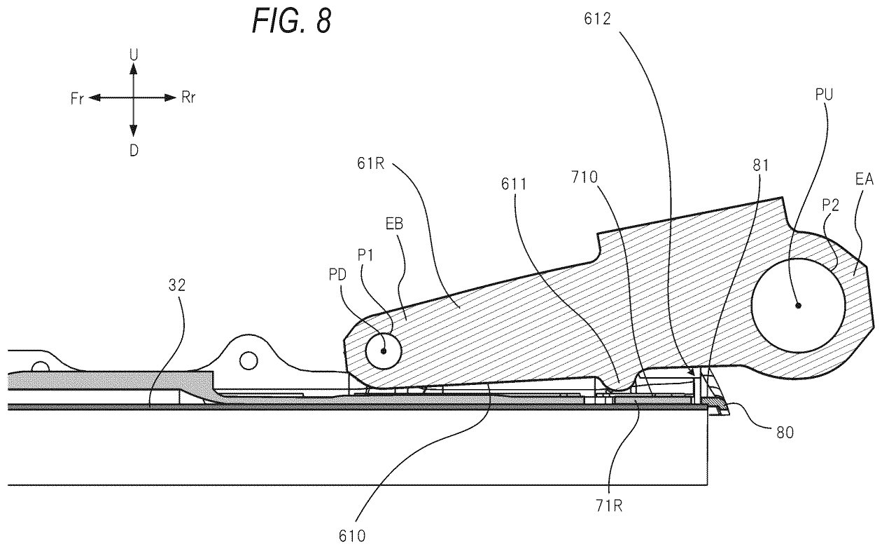

FIGS. 7 and 8 are schematic cross-sectional views illustrating the plane perpendicular to the left-right direction passing through a middle point in the thickness direction of the right rear link member 61R. FIG. 7 illustrates a state where the seat cushion 1 is set to a highest position by the seat lifter device 6. FIG. 8 illustrates a state where the seat cushion 1 is set to a lowest position by the seat lifter device 6. FIGS. 7 and 8 illustrate a center PD of the supported portion P1, a center PU of the supported portion P2, a line segment LA connecting the center PD and the center PU, and a straight line LB passing through a middle point of the line segment LA and perpendicular to the line segment LA.

As illustrated in FIG. 8, the concave portion 612 is provided in a region overlapping the cover member 80 as viewed in the up-down direction in the state where the seat cushion 1 is set to the lowest position by the seat lifter device 6. According to such a configuration, when the right rear link member 61R approaches the cover member 80 due to a load at a moment when the occupant sits on the seat cushion 1 from the state illustrated in FIG. 8, the concave portion 612 can also prevent the contact between the right rear link member 61R and the cover member 80. Accordingly, the cover member 80 can be prevented from being damaged.

A region of the end surface 610 of the right rear link member 61R on an end portion EB (supported portion P1) side with respect to the concave portion 612 abuts against the riser 71R when the end portion EA of the right rear link member 61R moves toward the vehicle body floor F due to the load when the occupant sits on the seat cushion 1 from the state where the seat cushion 1 is at the lowest position.

Specifically, a convex portion 611 protruding toward the vehicle body floor Fis provided in the region of the end surface 610 of the right rear link member 61R on the end portion EB (supported portion P1) side with respect to the concave portion 612. The convex portion 611 has a curved surface.

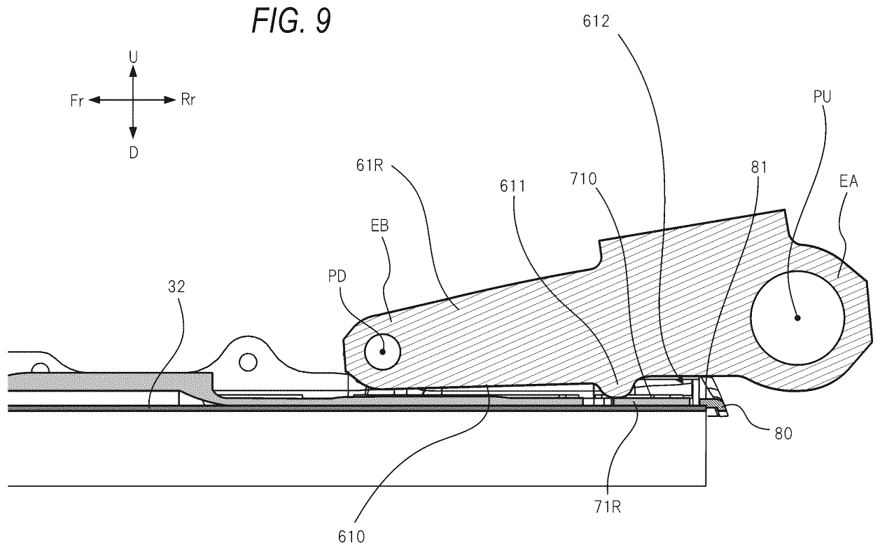

FIG. 9 illustrates the state where the end portion EA of the right rear link member 61R moves toward the vehicle body floor F due to the load when the occupant sits on the seat cushion 1 from the state illustrated in FIG. 8. As illustrated in FIG. 9, the convex portion 611 can abut against the bottom surface portion 710 of the riser 71R. In this way, the convex portion 611 abuts against the bottom surface portion 710 of the riser 71R, thereby preventing the right rear link member 61R from moving further toward the vehicle body floor F. Accordingly, it is possible to prevent the right rear link member 61R and the right side frame 11R that supports the right rear link member 61R from abutting against the cover member 80 and damaging the cover member 80.

As illustrated in FIG. 7, the convex portion 611 is provided closer to the supported portion P2 (end portion EA) than an intermediate position between the supported portion P1 and the supported portion P2. Even when the convex portion 611 is provided closer to the supported portion P1 than the intermediate position, it is possible to obtain the above effect. In this way, in order to sufficiently ensure a pivot amount of the right rear link member 61R, the supported portion P1 needs to be positioned upward in the up-down direction. When the convex portion 611 is provided closer to the supported portion P2 than the intermediate position, the supported portion P1 can be brought close to the vehicle body floor F, thereby implementing the vehicle seat 100 with a lower hip point.

In the vehicle seat 100 in which the position of the supported portion P1 is lowered, a distance between the cover member 80 and the end surface 610 of the right rear link member 61R becomes smaller in the state illustrated in FIG. 8. In the present embodiment, the concave portion 612 is provided in the end surface 610, and thus a region of the end surface 610 that can come into contact with the cover member 80 can be moved upward, and the damage to the cover member 80 can be prevented while lowering the hip point.

The region of the end surface 610 on the supported portion P1 side with respect to the concave portion 612 may be linearly connected from an apex of the concave portion 612 to the end portion EB as indicated by a virtual line VL in FIG. 7. With this configuration, the concave portion 612 can also prevent the contact between the cover member 80 and the right rear link member 61R. As compared with the configuration of being linearly connected from the apex of the concave portion 612 to the end portion EB as indicated by the virtual line VL, according to the configuration of the present embodiment, there is no portion between the virtual line VL in FIG. 7 and the end surface 610, and thus it is possible to reduce a mass of the right rear link member 61R by eliminating this portion. An abut location of the right rear link member 61R with the riser 71R can be limited to only the convex portion 611, and thus a strength of both the riser 71R and the right rear link member 61R can be maintained.

Although not illustrated, it is preferable that the rear end portion of the riser 71L is also provided with a cover member with which the rear end portion is covered. The pivoting of left rear link member 61L is restricted by the meshing of the pinion gear 64 and the sector gear 67. Therefore, an end portion of the left rear link member 61L on a torque rod 60 side is also restricted from moving downward due to the load when the occupant sits on the seat cushion 1 in the state where the seat cushion 1 is at the lowest position. Therefore, it is not essential to provide a concave portion in an end surface of the left rear link member 61L on the vehicle body floor F side in order to avoid the contact with the cover member with which the rear end portion of the riser 71L is covered. On the other hand, an end portion of the right rear link member 61R on the torque rod 60 side can move downward due to the load applied to the seat cushion 1. Therefore, it is particularly effective to provide the above concave portion 612 or convex portion 611.

As described above, the following matters are disclosed in the present specification. In the following parentheses, corresponding components and the like in the above embodiment are described, but the present invention is not limited thereto.
(1) A vehicle seat including:
a seat cushion (seat cushion 1); and
a height adjustment mechanism (seat lifter device 6) for the seat cushion, in which the height adjustment mechanism includes:
   a link member (right rear link member 61R) having one end pivotably supported by the seat cushion; and
   a support member (riser 71R) provided between a placement surface (vehicle body floor F) on which the vehicle seat is placed and the seat cushion, and configured to pivotably support an other end of the link member,
the support member extends toward a rear side of the seat cushion than the other end of the link member,
the vehicle seat further includes a cover member (cover member 80) with which an end portion of the support member on the rear side of the seat cushion is covered, and
an end surface (end surface 610) of the link member on a side of the placement surface is provided with a concave portion (concave portion 612) recessed to a side opposite to the side of the placement surface, the concave portion provided between a first supported portion (supported portion P1) supported by the support member and a second supported portion (supported portion P2) supported by the seat cushion.

According to (1), even in the case where the one end of the link member moves toward the placement surface and approaches the cover member due to a load at a moment when an occupant sits on the seat cushion, the concave portion can also prevent the contact between the link member and the cover member. Accordingly, it is possible to prevent the cover member from being damaged and maintain the aesthetic appearance of the vehicle seat. When no concave portion is provided, it is necessary to provide the first supported portion at a position far from the placement surface such that the link member and the cover member do not come into contact with each other. However, by providing the concave portion, the contact between the link member and the cover member can also be prevented when the first supported portion is brought close to the placement surface. Therefore, a height adjustment range of the seat cushion can be sufficiently secured by lowering a hip point.
(2) The vehicle seat according to (1), in which
the concave portion is provided in a region overlapping the cover member as viewed in a height direction of the seat cushion, in a state where the seat cushion is at a lowest position by the height adjustment mechanism.

According to (2), even in a case where the link member approaches the cover member due to the load at a moment when the occupant sits on the seat cushion, the concave portion can also prevent the contact between the link member and the cover member.
(3) The vehicle seat according to (2), in which
a region of the end surface of the link member on a side of the other end of the link member with respect to the concave portion is configured to abut against the support member in a case where the one end of the link member moves toward the placement surface from the state where the seat cushion is at the lowest position.

According to (3), the region of the link member abuts against the support member, whereby the further movement of the link member toward the placement surface is prevented. Therefore, for example, the frame of the seat cushion that supports the one end of the link member can be prevented from coming into contact with the cover member. Accordingly, it is possible to further prevent the cover member from being damaged and maintain the aesthetic appearance of the vehicle seat.
(4) The vehicle seat according to (3), in which
the region of the link member on the side of the other end of the link member is provided with a convex portion (convex portion 611) protruding toward the placement surface, and
the convex portion is configured to abut against the support member.

According to (4), the convex portion of the link member abuts against the support member, whereby the further movement of the link member toward the placement surface is prevented. Accordingly, the cover member can be prevented from being damaged. In addition, the convex portion can restrict the movement of the link member, and thus the link member can be reduced in weight.
(5) The vehicle seat according to (4), in which
the convex portion is provided closer to the second supported portion than an intermediate position between the first supported portion and the second supported portion.

According to (5), a support point of the link member on the support member can be brought close to the placement surface, and the hip point can be lowered.

What is claimed is:

1. A vehicle seat comprising:
a seat cushion; and
a height adjustment mechanism for the seat cushion, wherein
the height adjustment mechanism includes:
a link member having one end pivotably supported by the seat cushion; and
a support member provided between a placement surface on which the vehicle seat is placed and the seat cushion, and configured to pivotably support an other end of the link member,
the support member extends toward a rear side of the seat cushion than the other end of the link member,
the vehicle seat further comprises a cover member with which an end portion of the support member on the rear side of the seat cushion is covered, and
an end surface of the link member on a side of the placement surface is provided with a concave portion recessed to a side opposite to the side of the placement surface, the concave portion being provided between a first supported portion supported by the support member and a second supported portion supported by the seat cushion.

2. The vehicle seat according to claim 1, wherein
the concave portion is provided in a region overlapping the cover member as viewed in a height direction of the seat cushion, in a state where the seat cushion is at a lowest position by the height adjustment mechanism.

3. The vehicle seat according to claim 2, wherein
a region of the end surface of the link member on a side of the other end of the link member with respect to the concave portion is configured to abut against the support member in a case where the one end of the link member moves toward the placement surface from the state where the seat cushion is at the lowest position.

4. The vehicle seat according to claim 3, wherein
the region of the link member on the side of the other end of the link member is provided with a convex portion protruding toward the placement surface, and
the convex portion is configured to abut against the support member.

5. The vehicle seat according to claim 4, wherein
the convex portion is provided closer to the second supported portion than an intermediate position between the first supported portion and the second supported portion.
